(19) United States
(12) Patent Application Publication
(10) Pub. No.: US 2007/0069882 A1
(43) Pub. Date: Mar. 29, 2007

(54) Intelligent exit sign

(76) Inventor: Kamal Mahajan, Greenlawn, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/528,213

(22) Filed: Sep. 27, 2006

Related U.S. Application Data
(60) Provisional application No. 60/720,907, filed on Sep. 27, 2005.

(51) Int. Cl. G08B 23/00

(52) U.S. Cl. 340/500; 362/812; 340/815.4; 40/570

(57) ABSTRACT

An emergency display panel includes a housing having a first surface mountable to a building structure. The housing includes a cavity defined therein and the housing includes circuitry adapted to connect to a remote networking source. A display surface extends from the housing and displays indicia thereon. At least one emergency detector such as a smoke detector, a carbon monoxide detector and gas detector is disposed within the housing.

### RELATED APPLICATION

This application claims priority to U.S. Provisional Application Ser. No. 60/720,907 filed on Sep. 27, 2005, the entirety of which is hereby incorporated by reference.

### BACKGROUND

The present disclosure relates generally to emergency equipment and devices including illuminated signs and emergency lighting units and particularly relates to emergency exit panels having multiple emergency functions in a single device.

### TECHNICAL FIELD

Emergency lighting capability is mandated by building codes throughout most of the world for commercial buildings, schools and in some instance large residential homes. The most common type of emergency lighting is a so-called “Exit Sign” which is also the most noticed due not only to its ubiquity but also due to the fact that most exit signs are constantly illuminated and are therefore readily seen.

Exit signs are typically placed above doorways or on emergency exit routes to indicate (in a time of emergency) the most efficient or safe manner of exiting a particular building. Another common form of emergency lighting is generally referred to as an emergency lighting unit and typically operates two spaced lamps which are often referred to as “frog eyes”. Emergency lighting units operate only in the event of emergency and are intended to supply an acceptable degree of ambient illumination under emergency conditions, these conditions usually including loss of normal power.

Since emergency conditions requiring the most immediate and effective use of both exit signs and emergency lighting units are normally associated with main power loss, backup power is necessary for the continued operation of an exit sign and for start-up and continuing operation of an emergency lighting unit. These two forms of emergency lighting, the exit sign and the emergency lighting unit, are placed in a building structure at locations requiring a particular function of each form. Certain situations require the use of both forms of emergency lighting in one location. Rather than use separate lighting fixtures in one particular location, common practice has been to use a “combination” exit sign and emergency lighting unit, this type of fixture being commonly referred to as an exit/unit combo.

The “exit/unit combo” has previously taken the form of an emergency lighting unit mounted to an exit sign, the emergency lighting unit most often being mounted along the top of the exit sign. In most instances, the exit sign and the emergency unit operate separately although certain functions can be shared between the exit sign and the unit by providing common circuitry such as would be useful to detect power line failure for switching the exit sign to DC battery power and for initiating operation of the emergency lighting unit.

A particular exit/unit combo which has enjoyed substantial market acceptance is the QUANTUM Exit/Unit Combo manufactured by Lithonia Lighting, Inc. of Conyers, Ga., a wholly owned subsidiary of National Service Industries, Inc., of Atlanta, Ga., QUANTUM being a trademark of National Service Industries, Inc. The widespread use of the Lithonia Lighting combo has been brought about at least in part due to the reduced labor costs associated with installation of the Lithonia combo on site, the exit sign and the emergency lighting unit being factory assembled and pre-wired for shipment to a job site in a configuration allowing rapid and simultaneous final wiring of both the exit sign and the emergency lighting unit. Further, the Lithonia combo manufactured and marketed under the QUANTUM mark is comprised of a substantially all-plastic exit sign and a substantially all-plastic emergency lighting unit, thereby resulting in a combo product which is light in weight.

While the QUANTUM combo evidenced significant advantages in this art, it lacks many additional features which may be needed for emergency detection and/or required during an emergency condition. Accordingly, the art has experienced a long-felt and continuing need for improvement of a combination exit sign and emergency lighting unit or combo unit.

### SUMMARY

The present disclosure relates to an emergency display combo unit or panel which includes a housing having a first surface mountable to a building structure. The housing includes a cavity defined therein and includes circuitry adapted to connect to a remote networking source and/or an emergency response station. A display surface extends from the housing and displays indicia thereon. At least one emergency detector such as a smoke detector, a carbon monoxide detector, leak detector and/or gas detector is disposed within the housing. The emergency display panel is powered by a battery and/or AC 110 V/220 V circuitry.

In one embodiment, the indicia displayed on the display surface is selectively inscribable, displayable or configurable via the remote networking source. In another embodiment, the housing includes a two-way communication system disposed therein accessible from the remote networking source or an emergency response station. The two-way communication system may include an audio communications means, e.g., microphone and audio speaker, and/or a visual communications means, e.g., video camera and video display.

In yet another embodiment, the housing and/or the display surface includes at least one additional emergency device selected from the group consisting of a strobe light, emergency lamps, laser pointer, directional indicator, video camera, microphone, audible alarm, voice alarm, intercom, battery indicator, public address system and combinations thereof. The additional emergency device(s) may be operatively coupled to the remote networking source and/or an emergency response station.

In another embodiment, the emergency display panel is selectively networkable to additional emergency display units or panels. In still other embodiments, the emergency display panel may be illuminated in a variety of colors and shades. The housing and/or the display surface may be configured to include a surveillance camera which may be remotely operated via the remote networking source and/or an emergency response station.

In one embodiment, the emergency display panel includes control circuitry which relays diagnostic information back to the remote networking source and/or an emergency response station. The emergency display panel may be connected to the remote networking source or an emergency response station via a hardwire connection and/or a wireless connection.

The emergency display panel may also be configured to include pre-recorded messages which are automatically broadcast in case of emergency or selectively broadcast from the remote networking source and/or an emergency response station. A motion sensor may be included in the housing or attached to the display surface. The motion sensor may be configured to activate a pre-determined message for display on the display surface or may be configured to provide information back to the remote networking source and/or an emergency response station.

The emergency display panel and the display surface may be made from a group of materials consisting of plastic construction materials, acrylic materials, metals, polypropylene, propylene and combinations thereof.

In yet another embodiment, the emergency display panel includes an interface for remotely connecting with at least a sensor and/or a detector which is configured to recognize a hazardous condition. The sensor and/or the detector may include a thermal detector, a smoke detector, a leak detector, a gas detector and a carbon monoxide detector and combinations thereof. The sensor and/or detector automatically may be configured to display a warning on the display surface relating to the hazardous condition.

In one embodiment, the sensor and/or detector automatically displays a warning on the display surface relating to the hazardous condition and relays information relating to the hazardous condition to the remote networking source and/or an emergency response station.

In still yet another embodiment, at least one sensor and/or detector (upon detection of a hazardous condition) automatically performs a secondary function and relays information relating to the hazardous condition to the remote networking source and/or an emergency response station. Secondary functions may include locking or unlocking at least one exit door, sounding an audible or visual alarm, continually relaying hazardous information back to at least one emergency panel relating to the hazardous condition, releasing a suppression material and/or combinations thereof.

The present disclosure also relates to an emergency display system which includes at least two emergency response panels which each include a housing having a first surface mountable to a building structure and which each include a cavity defined therein. Each of the housings is adapted to connect to a remote networking source. A display surface extends from each housing and displays indicia thereon. At least one emergency detector (e.g., a smoke detector, a heat or thermal detector, a leak detector, a carbon monoxide detector and/or a gas detector) is disposed within at least one of the housings. The emergency response panels are operatively coupled (i.e., in electrical and/or mechanical communication) to one another and at least one of which is configured to relay information to the other, the remote networking source or emergency response station directly or via the remote networking source.

At least one of the emergency display panels may include an interface for remotely connecting with a sensor and/or a detector which is configured to recognize a hazardous condition. In one embodiment, at least one of the emergency display panels includes an algorithm which configures each of the display surfaces with indicia or provides an audible warning relating to the hazardous condition. The indicia displayed on the display surfaces or the audible warning may include at least one of a safe exit route, alternate exit route, hazardous condition, warning, prompt, and/or combinations thereof.

### BRIEF DESCRIPTION OF THE DRAWINGS

Various embodiments of the subject instrument are described herein with reference to the drawings wherein:

FIG. 1 is a schematic right, perspective view of one embodiment of an emergency display panel in accordance with the present disclosure;

FIG. 2 is a schematic right, perspective view of another embodiment of an emergency display panel in accordance with the present disclosure;

FIG. 3 is a schematic right, perspective view of another embodiment of an emergency display panel in accordance with the present disclosure for use with a remote detector; and

FIG. 4 is a schematic diagram of one embodiment of an emergency display system in accordance with the present disclosure.

### DETAILED DESCRIPTION

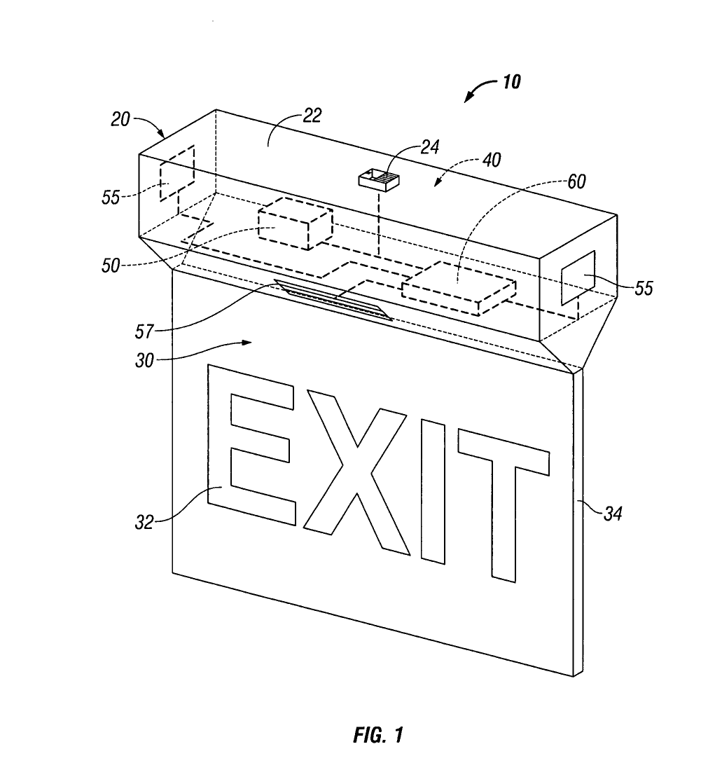

Referring now to FIG. 1, one embodiment of the presently disclosed emergency display panel is shown and is generally designated as reference numeral 10. Panel 10 includes a housing 20 having a first or top surface 22 which is designed to mount to a ceiling or other building structure. Other surfaces of the housing 20 may also be mountable to a building structure but are not shown. Housing 20 includes a cavity 40 defined therein for housing various electrical and/or mechanical components therein as explained in more detail below. A display surface 30 is configured to extend or downwardly depend from housing 20. Display surface 30 is preferably flat and contains electronic circuitry (not shown) therein for displaying any form of text or graphic indicia 32 thereon. Display surfaces 30 are commonly known in the art and are envisioned herein and include LED displays, gas-enhanced displays, CRT's, etc. Other types of displays are also envisioned which may be more simplified and include illuminated or non-illuminated graphic displays of any color, shade or illumination intensity. The indicia displayed on the display surface may be selectively displayable, writeable or inscribable via a remote networking source 600 and/or an emergency response station 700. Alternatively, the display surface may display predetermined indicia via control circuitry disposed within the housing 20 as explained below.

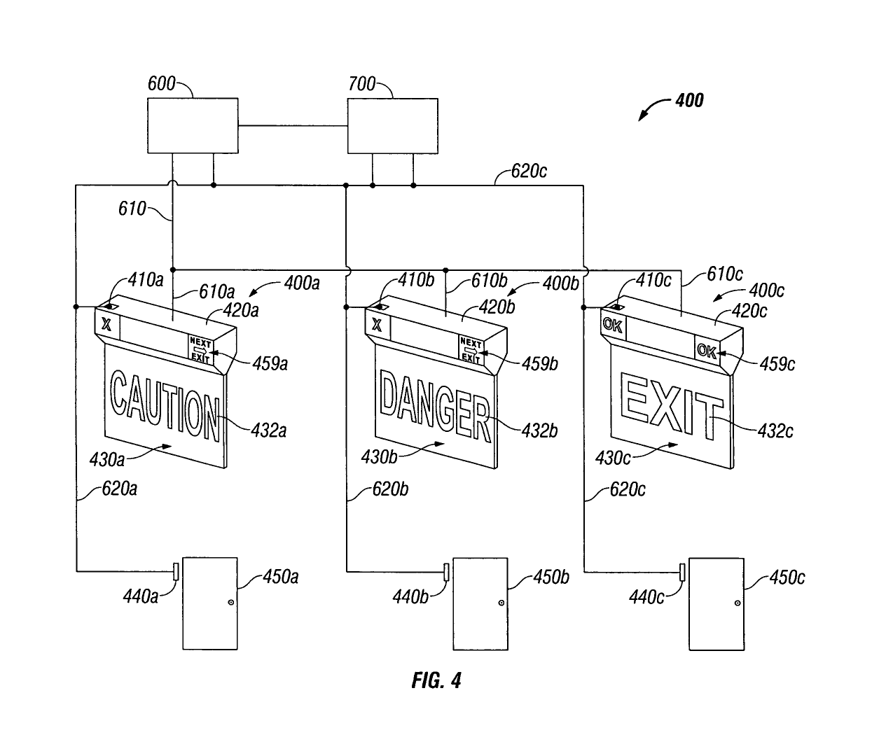

As mentioned above, housing 20 is preferably dimensioned to house various electrical and mechanical components within cavity 40 defined therein. As such and depending upon the particular items associated with the panel 10, the housing 20 may vary in shape and size. One or more emergency detectors 50 are disposed within the housing and electronically coupled to a printed circuit board (PCB) 60, flexible circuit board (FCB) (not shown) or other known type of electrical circuitry. The emergency detector(s) is configured to detect the presence of one or more hazardous conditions and relay the information back to the PCB 60 or directly back to the remote networking source 600 and/or the emergency response station 700 (See FIG. 4) via connection port 24. The emergency detector 50 may be any one of the following type of detectors: smoke detectors, carbon monoxide detectors, gas detectors, thermal detectors, leak detectors, water detectors and/or combinations thereof.

As mentioned above, the housing 20 may be configured to accommodate one or more of these types of detectors depending upon a particular purpose. Moreover, it is envisioned that the PCB 60 may be configured to recognize the type of detector automatically in a modular assembly system, i.e., plug and play. In this instance, different detectors may be employed in panels which have different potential hazardous conditions. The manufacturer upon custom order simply mounts one or more particular-type detectors 50 into the housing 20 and the PCB 60, the remote networking source 600 or the emergency response station 700 will recognize via standard TCP/IP protocols, plug and play or other commonly known handshaking technologies. It is also envisioned that the PCB 60 may be configured to relay diagnostic information back to the remote networking source 600 and/or the emergency response station 700. The remote networking source 600 and/or the emergency response station 700 may be connected to one or more panels 10 via a hardwired 63, modular port 24 or wireless connection 61.

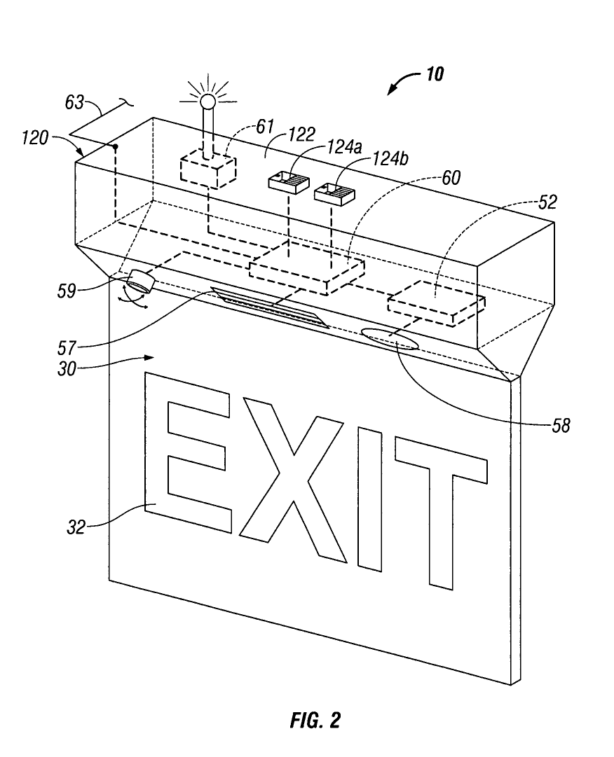

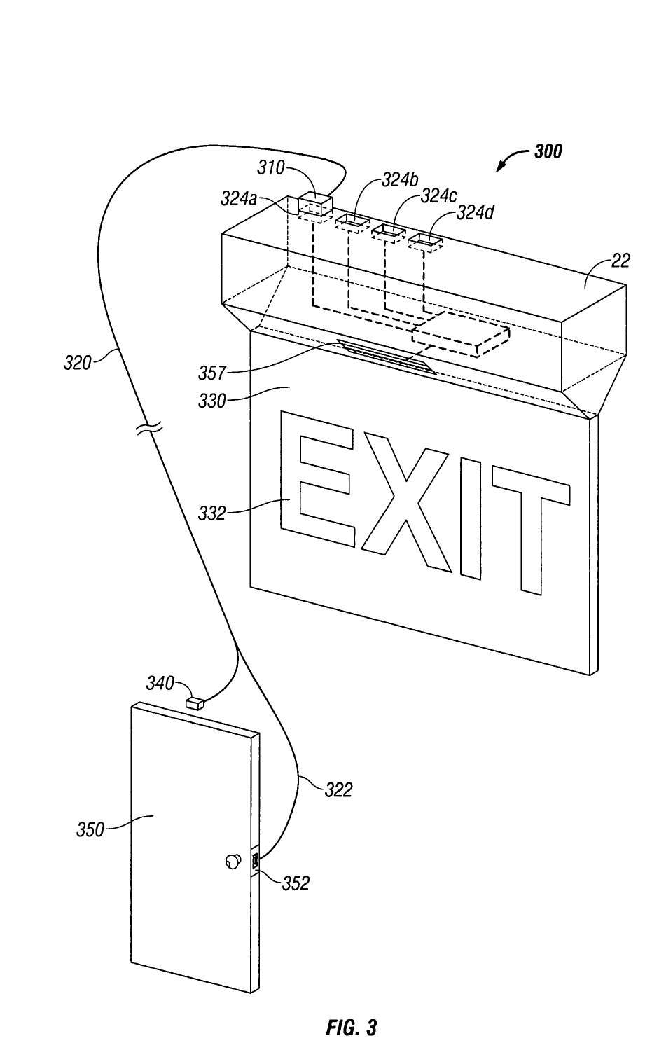

As mentioned above, the housing includes a connection port 24 which electrically connects to the PCB (or directly to the detector(s) 50) and provides an electrical connection to the remote networking source 600 and/or the emergency response station 700. Additional connection ports 24 may be utilized (See FIGS. 2 and 3—ports 124a, 124b and 324a, 324b, 324c, 324d) to connect to other devices which include diagnostic devices, remote detection devices (e.g., 340, 440a, 440b and 440c), additional emergency display panels 10, emergency telephones, etc.

Port 24 enables the panel 10 to communicate with remote networking source 600 or the emergency response station 700. For example, it is envisioned that the panel 10 may be configured to simply relay information to remote networking source 600 or the emergency response station 700 or the panel 10 may include a two-way communication system 52 (FIG. 2) disposed therein which is readily accessible from the remote networking source 600 and/or the emergency response station 700. The two-way communications system 52 may include audio communication devices 57, (e.g., microphone and speakers) and/or visual communications devices 58 (e.g., cameras and displays). The two-way communications system 52 may be connected to the PCB and/or directly to the remote networking source 600 and/or the emergency response station 700. It is also contemplated that the two-way communications system 52 may include a surveillance camera 59 (FIG. 2) which is remotely operated and controlled both electronically and/or mechanically (i.e., rotation and scanning) via the remote networking source 600 and/or the emergency response station 700.

The housing and/or the display surface may be configured to include one or more additional emergency devices 55 such as a strobe light, an emergency lamp, a laser pointer, a directional indicator, an audible alarm, a voice alarm, an intercom, a battery indicator and/or a public address system. The one or more additional emergency devices 55 may be operatively coupled to the PCB 60, remote networking source 600 and/or the emergency response station 700.

The emergency display panel 10 may be configured to include pre-recorded messages (e.g., programmed into PCB 60) which are automatically broadcast in case of emergency or selectively broadcast from the remote networking source 600 and/or an emergency response station 700. Moreover, the emergency display panel 10 and/or the display surface are made from a group of materials consisting of plastic construction materials, acrylic materials, metals, polypropylene, propylene and combinations thereof. The emergency display panel may be powered by AC 110 V/220 V circuitry with at least one battery backup, AC only or battery standalone systems.

In one particularly useful envisioned embodiment shown in FIG. 3, an emergency display panel 300 is shown which includes an interface 310 connectable or interfaceable at one end to port 324a and at the other end connectable or interfaceable with a remote device 340 (e.g., a sensor and/or a detector). Remote device 340 may be configured to sense or detect a substance, motion, heat, smoke, carbon monoxide, a leak or recognize a generally hazardous condition. The remote device 340 (once activated) may be programmed to perform a secondary function. For example, in the instance that the remote device 340 is a motion detector, the emergency display panel 300 upon motion detection (i.e., movement of a person or animal) may be configured to perform a secondary function. The secondary functions may include activating a pre-determined or pre-programmed message, opening or locking a door, alerting a security agent, relaying motion information back to the remote networking source and/or emergency response station, sounding an alarm, activating a camera, releasing a suppression material (water, CO2 or other fire suppression agents) illuminating one or more emergency panel(s), providing an audible or visual warning and/or combinations thereof.

In the instance that the remote device is a smoke or heat detector, the secondary function may be to lock the exit door and/or provide a warning on the display surface 330. The remote device 340 may also be used to as a safeguard for assuring safe passage through a particular door or window in a building structure and may cooperate with the display surface 330 to sound or display an “ALL CLEAR” or “SAFE PASSAGE” message to escapees. The remote device 340 may also be utilized by fire or security safety personnel to facilitate or coordinate exit routing during an emergency situation.

FIG. 4 shows a schematic representation of another embodiment of the present disclosure which relates to an emergency display system 400. System 400 includes a series of emergency response panels 400a, 400b and 400c which each include a housing 420a, 420b and 420c, respectively, mountable to a building structure. Each of the housings 420a, 420b and 420c includes a cavity defined therein and circuitry (e.g., PCB 60—See FIG. 1)) adapted to connect to a remote networking source 600 or emergency response station 700. Much like the aforementioned embodiments, a display surface 430a, 430b and 430c is included with each respective panel 400a, 400b and 400c which extends from each housing 420a, 420b and 420c and displays indicia 432a, 432b and 432c thereon. Any one of the aforementioned embodiments and any combination of the various features and detectors (smoke, carbon monoxide, gas, water, leak, thermal, etc.) relating thereto may be used with system 400. Moreover, the panels 400a, 400b and 400c may all be the same type panel with the same type detectors and remote connections or each panel 400a, 400b and 400c may be unique depending upon a particular purpose. At least one of emergency response panels e.g., 400a, is configured to relay information to the other panels 400b and 400c, the remote networking source 600 and/or emergency response station 700 directly or via a wireless connection.

As shown in FIG. 4, the emergency display panels 400a, 400b and 400c include interfaces 410a, 410b, 410c for remotely connecting with a sensor and/or detector 440a, 440b and 440c which is configured to recognize a hazardous condition much like the aforedescribed embodiments above. For example, the remote sensor or detector may be positioned proximate one or more doors or fire exits 450a, 450b and 450c. When the detector(s) 440a, 440b and 440c is activated or tripped, the fire exit or door 450 may be locked or unlocked or a signal relating to the hazardous condition may be relayed over the network to display a warning.

It is envisioned that the remote networking source 600, the emergency response station 700 and/or one or more emergency display panels 400a-400c may include an algorithm which configures each of the display surfaces 430a-430c with respective indicia 432a-432c or provides an audible warning relating to the hazardous condition. The indicia 432a-432c displayed on the respective display surfaces 430a-430c (or audible warning) may include information relating to a safe exit route, an alternate exit route, a hazardous condition, a warning, a caution, a prompt and/or combinations thereof. Directional indicators 459a, 459b and 459c may also be disposed on the housings 420a-420c and integrated into the control circuitry of the network (or each individual panel 400a-400c) to provide directional information (i.e., directional arrows) or status information (“caution”, “safe”, “okay”, etc.).

The panels 400a-400c may include wireless connections or be hardwired via electrical leads 610a, 610b and 610c to the remote networking source 600, the emergency response station 700 and/or other panels 400a-400c. The detectors 440a-440c may include wireless connections or may be hardwired via electrical leads 620a, 620b and 620c to the panels 400a-400c, the remote networking source 600 and/or the emergency response station 700.

From the foregoing and with reference to the various figure drawings, those skilled in the art will appreciate that certain modifications can also be made to the present disclosure without departing from the scope of the present disclosure. For example, although several of the panels shown in FIGS. 1-4 include a variety of different detectors, PCB, secondary devices and other components, it is envisioned that any panel may be constructed using only one particular component. Moreover, any combination of components may be employed with any panel depending upon a particular purpose.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. An emergency display panel, comprising:
a housing having a first surface mountable to a building structure, said housing including a cavity defined therein, said housing including circuitry adapted to connect to at least one of a remote networking source and emergency response station;
a display surface extending from said housing which displays indicia thereon; and
at least one emergency detector disposed within said housing, said emergency detector being selected from the group consisting of a smoke detector, a carbon monoxide detector, a gas detector, a leak detector and a water detector and combinations thereof.

2. An emergency display panel according to claim 1 wherein said indicia displayed on said display surface is selectively inscribable via said remote networking source.

3. An emergency display panel according to claim 1 wherein said housing includes a two-way communication system disposed therein accessible from at least one of said remote networking source and an emergency response station, said two-way communication system including at least one of an audio communications means and a visual communications means.

4. An emergency display panel according to claim 1 wherein at least one of said housing and said display surface includes at least one additional emergency device selected from the group consisting of a strobe light, emergency lamps, laser pointer, directional indicator, video camera, microphone, audible alarm, voice alarm, intercom, battery indicator and public address system.

5. An emergency display panel according to claim 4 wherein said at least one additional emergency device is operatively coupled to at least one of said remote networking source and an emergency response station.

6. An emergency display panel according to claim 1 wherein said emergency display panel is selectively networkable to additional emergency display panels.

7. An emergency display panel according to claim 1 wherein said emergency display panel may be illuminated in a variety of colors and shades.

8. An emergency display panel according to claim 1 wherein at least one of said housing and said display surface includes a surveillance camera which is remotely operated via at least one of said remote networking source and an emergency response station.

9. An emergency display panel according to claim 1 wherein said emergency display panel includes control circuitry which relays system diagnostic information back to at least one of said remote networking source and an emergency response station.

10. An emergency display panel according to claim 1 wherein said emergency display panel is connected to a remote source via at least one of a hardwire connection and a wireless connection.

11. An emergency display panel according to claim 1 wherein said emergency display panel includes pre-recorded messages which are automatically broadcast in case of emergency or selectively broadcast from at least one of said remote networking source and an emergency response station.

12. An emergency display panel according to claim 1 wherein said emergency display panel includes a motion sensor.

13. An emergency display panel according to claim 12 wherein said motion sensor activates a pre-determined message for display on said display surface.

14. An emergency display panel according to claim 1 wherein said emergency display panel and said display surface are made from a group of materials consisting of plastic construction materials, acrylic materials, metals, polypropylene, propylene and combinations thereof.

15. An emergency display panel according to claim 1 wherein said emergency display panel is powered by at least one of a battery and AC 110 V/220 V circuitry.

16. An emergency display panel according to claim 1 wherein said emergency display panel includes an interface for remotely connecting with at least one of a sensor and detector which is configured to recognize a hazardous condition.

17. An emergency display panel according to claim 16 wherein said at least one of a sensor and detector is selected from the group consisting of thermal detector, smoke detector, gas detector and carbon monoxide detector.

18. An emergency display panel according to claim 16 wherein said at least one of a sensor and detector automatically displays a warning on said display surface relating to the hazardous condition.

19. An emergency display panel according to claim 16 wherein said at least one of a sensor and detector automatically displays a warning on said display surface relating to the hazardous condition and relays information relating to said hazardous condition to at least one of said remote networking source and an emergency response station.

20. An emergency display panel according to claim 16 wherein said at least one of a sensor and detector upon detection of a hazardous condition automatically performs a secondary function and relays information relating to said hazardous condition to at least one of said remote networking source and an emergency response station.

21. An emergency display panel according to claim 20 wherein said secondary function includes at least one of locking or unlocking at least one exit door, sounding an audible or visual alarm, relaying hazardous information back to at least one emergency panel relating to the hazardous condition, releasing a suppression material and combinations thereof.

22. An emergency display system, comprising:
at least two emergency response panels which each include a housing having a first surface mountable to a building structure, each of said housings including a cavity defined therein and each of said housings including circuitry adapted to connect to at least one of a remote networking source and emergency response station;
a display surface extending from said housing which displays indicia thereon;
at least one emergency detector disposed within at least one of said housings, said emergency detector being selected from the group consisting of a smoke detector, a carbon monoxide detector and gas detector;
said at least two emergency response panels operatively coupled to one another for relaying information therebetween directly, via said remote networking source or via emergency response station.

23. An emergency display system according to claim 22 wherein at least one of emergency response panels is configured to relay information to the other, the remote networking source or emergency response station directly or via said remote networking source.

24. An emergency display system according to claim 22 wherein at least one of said emergency display panels includes an interface for remotely connecting with at least one of a sensor and detector which is configured to recognize a hazardous condition.

25. An emergency display system according to claim 24 wherein at least one of said emergency display panels includes an algorithm which configures each of said display surfaces with indicia or provides an audible warning relating to said hazardous condition.

26. An emergency display system according to claim 25 wherein said indicia displayed on said display surfaces or audible warning include at least one of a safe exit route, alternate exit route, hazardous condition, warning, prompt, and combinations thereof.
